(19) United States
(12) Patent Application Publication
(10) Pub. No.: US 2018/0095440 A1
(43) Pub. Date: Apr. 5, 2018

(54) NON-TRANSITORY COMPUTER-READABLE STORAGE MEDIUM, ACTIVATION CONTROL METHOD, AND ACTIVATION CONTROL DEVICE

(71) Applicant: FUJITSU LIMITED, Kawasaki-shi (JP)

(72) Inventors: Tomoaki Masuda, Numazu (JP); Masayuki Igura, Numazu (JP); Yosuke Kondo, Numazu (JP); Ryota Kuribayashi, Numazu (JP); Kazuma Kitano, Oota (JP)

(73) Assignee: FUJITSU LIMITED, Kawasaki-shi (JP)

(21) Appl. No.: 15/720,579

(22) Filed: Sep. 29, 2017

(30) Foreign Application Priority Data
Oct. 5, 2016 (JP) 2016-197582

(51) Int. Cl. G05B 19/042; G06F 9/30

(52) U.S. Cl. CPC G05B 19/0426; G06F 2009/4557; G06F 9/30079

(57) ABSTRACT

A non-transitory computer-readable storage medium storing an activation control program that causes a computer to execute a process, the process including specifying a time until a specific access to each of a plurality of virtual machines has been detected after an activation of each of the plurality of virtual machines based on pieces of activation history data of the plurality of virtual machines, determining activation order for the plurality of virtual machines based on the specified times, and activating the plurality of virtual machines in accordance with the determined activation order.

### CROSS-REFERENCE TO RELATED APPLICATION

This application is based upon and claims the benefit of priority of the prior Japanese Patent Application No. 2016-197582, filed on Oct. 5, 2016, the entire contents of which are incorporated herein by reference.

### FIELD

The embodiments discussed herein are related to a non-transitory computer-readable storage medium, an activation control method, and an activation control device.

### BACKGROUND

As a configuration of a cloud service, there is a service called a private cloud. For example, in the private cloud, there is a case in which a desktop environment or the like of a user such as a person who works for a company is realized through a virtual machine.

However, in the private cloud, computer resources are allocated within the company, so that there is a case in which activation of virtual machines are concentrated on a specific time, for example, a business starting time or the like.

To deal with such a load, as an example, it has been proposed that a virtual machine is deployed to a host in which the load does not easily rise, with reference to the trend of the activation stop, or a virtual machine is activated after being moved to a host in which the load is small at the time of the activation.

Japanese Laid-open Patent Publication No. 2005-301797, Japanese Laid-open Patent Publication No. 2014-010772, and Japanese Laid-open Patent Publication No. 05-282164 are the related arts.

### SUMMARY

According to an aspect of the invention, a non-transitory computer-readable storage medium storing an activation control program that causes a computer to execute a process, the process including specifying a time until a specific access to each of a plurality of virtual machines has been detected after an activation of each of the plurality of virtual machines based on pieces of activation history data of the plurality of virtual machines, determining activation order for the plurality of virtual machines based on the specified times, and activating the plurality of virtual machines in accordance with the determined activation order.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration example of a cloud system according to a first embodiment;

FIG. 2 is a block diagram illustrating an example of a functional configuration of an activation control device according to the first embodiment;

FIG. 3 is a diagram illustrating an example of activation setting data,

FIG. 4 is a diagram illustrating an example of activation history data,

FIG. 5 is a diagram illustrating an example of a correspondence relationship between a time difference and a daily addition value;

FIG. 6 is a diagram illustrating an example of a calculation result of points;

FIG. 7 is a flowchart illustrating a procedure of history registration processing according to the first embodiment;

FIG. 8 is a flowchart illustrating a procedure of priority level update processing according to the first embodiment;

FIG. 9 is a flowchart illustrating a procedure of activation control processing according to the first embodiment; and

FIG. 10 is a diagram illustrating a hardware configuration example of a computer that executes an activation control program according to the first embodiment and a second embodiment.

### DESCRIPTION OF EMBODIMENTS

However, in the above-described technology, a standby time until the virtual machine is activated may occur.

That is, the above-described technology in the related arts tries to suppress the occurrence of activation instructions of virtual machines at the same time in the same host, but it may be difficult to suppress the problem completely in practice. In addition, when activation instructions of virtual machines occur at the same time in the same host, a time difference occurs between the activation of the plurality of virtual machines. For example, a case may occur in which a virtual machine not immediately used by the user at a stage at which the virtual machine has been activated is activated earlier, or a virtual machine immediately used by the user at a stage at which the virtual machine has been activated is activated later. As described above, there is a case in which a standby time occurs until a time at which a virtual machine is activated after a time at which an activation instruction of the virtual machine is issued.

An object of an aspect of the disclosure is to provide a storage medium storing an activation control program by which an activation standby time of a virtual machine is reduced, an activation control method, and an activation control device.

Embodiments of a storage medium storing an activation control program, an activation control method, and an activation control device of the technology discussed herein are described below with reference to the accompanying drawings. The technology discussed herein is not limited to such embodiments. In addition, the embodiments may be combined as appropriately in a range to the extent that processing contents do not conflict.

### First Embodiment

[System Configuration]

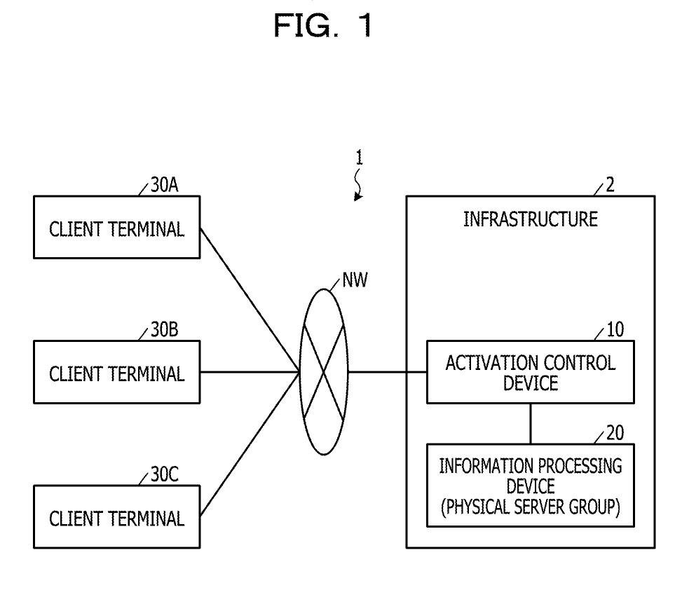

FIG. 1 is a configuration example of a cloud system according to the first embodiment. A cloud system 1 illustrated in FIG. 1 provides a cloud service such as Infrastructure as a Service (IaaS), that is, a so-called private cloud for client terminals 30A to 30C through virtualization of servers, which is executed by an information processing device 20.

In the cloud system 1 illustrated in FIG. 1, an activation control device 10, the information processing device 20, and the client terminals 30A to 30C are accommodated. In FIG. 1, for convenience of explanation, three client terminals are illustrated, but the three client terminals are only examples, and the cloud system 1 may accommodate the specific number of client terminals. Hereinafter, the client terminals 30A to 30C may be collectively referred to as a “client terminal 30”.

The activation control device 10 and each of the client terminals 30 are coupled to each other so as to communicate with each other through a network NW. As such a network NW, a certain type of a communication network such as the Internet, a local area network (LAN), or a virtual private network (VPN) may be used regardless of whether a network is wired or wireless.

The client terminal 30 is a terminal device used by a user. Here, the “user” is a general person who works for an organization such as a company that operates the cloud system 1, and for example, a person who utilizes a function provided by a virtual machine, which is realized through virtualization of a server, for example, a desktop environment or the like.

As an embodiment, various mobile terminal devices may be used as the client terminals 30 in addition to personal computers. For example, examples of the mobile terminal device include a mobile communication terminal such as a smartphone, a mobile phone, and a personal handyphone system (PHS), and a slate terminal such as a personal digital assistant (PDA). As an example, the client terminal 30 as which a certain type of an information processing device is used as described above is provided as a zero client or a thin client.

The information processing device 20 is a computer that provides a service such as IaaS for the client terminal 30.

As an embodiment, the information processing device 20 is built so as to include one or more host machines. In addition, virtualization software that realizes virtualization of a computer, for example, software such as a hypervisor or the like is provided in the information processing device 20. Under such provision, when the information processing device 20 has accepted an activation instruction of a virtual machine from the activation control device 10, the information processing device 20 allocates various resources to the virtual machine from a resource pool in which information and communication technology (ICT) resources has been pooled. For example, the information processing device 20 allocates, to the virtual machine, usages of a central processing unit (CPU), a memory, and a disk, which correspond to a template that has been set to the virtual machine the activation instruction of which has been accepted, for example, types of the performance of the CPU and the capacity of the disk. In addition, the information processing device 20 allocates a resource of the network, for example, a network interface card (NIC), to the above-described virtual machine. After the allocation of these resources, the information processing device 20 creates a disk image of the virtual machine and activates the virtual machine using the disk image.

The activation control device 10 is a computer that provides an activation control service by which the virtual machine used by the client terminal 30 is activated manually or automatically as part of the above-described private cloud.

As an embodiment, the activation control device 10 may be provided so that an activation control program that realizes a function related to the above-described activation control service is installed in a desired computer as package software or online software. Here, in FIG. 1, for convenience of explanation, a case is described in which the activation control device 10 in which the function related to the above-described activation control service has been extracted is implemented separately from the information processing device 20, but the function may be implemented in the information processing device 20. In that case, as an example, add-on of the function related to the above-described activation control service may be performed on IaaS management software executed as one of guest operating systems (OS) of pieces of virtualization software on the information processing device 20.

In the cloud system 1, an infrastructure 2 may be provided as an on-premise type managed by a party in charge such as a company or may be provided as a hosted type managed by a third party such as a cloud operator.

[Configuration of the Activation Control Device 10]

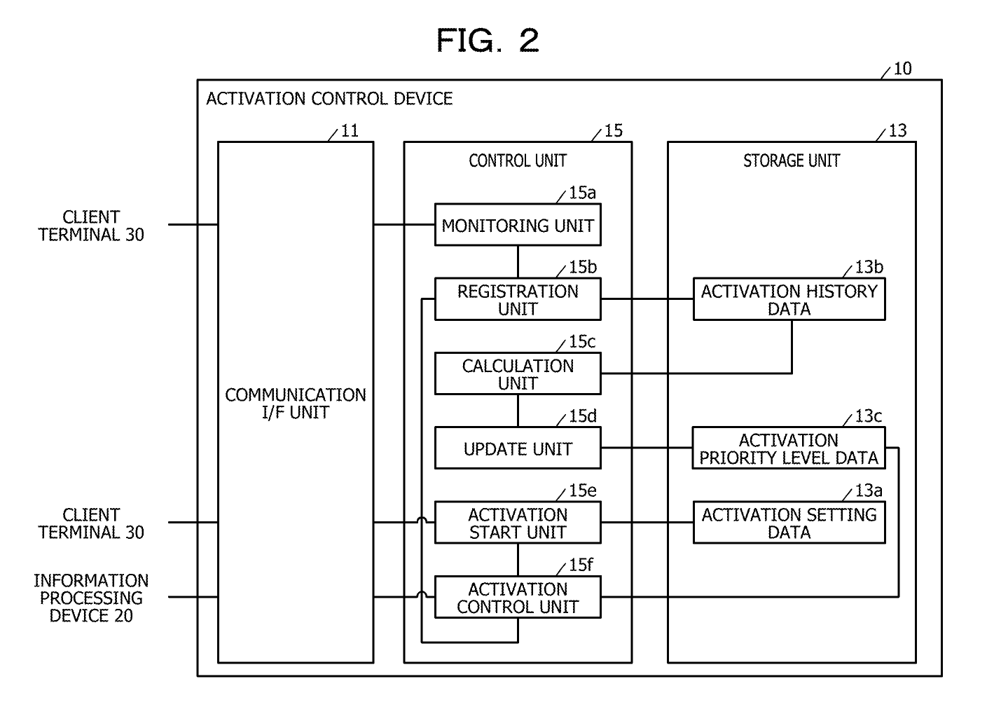

FIG. 2 is a block diagram illustrating an example of a functional configuration of the activation control device 10 according to the first embodiment. As illustrated in FIG. 2, the activation control device 10 includes a communication interface (I/F) unit 11, a storage unit 13, and a control unit 15. In FIG. 2, a solid line indicating a relationship of reception and transmission of data is illustrated, but in FIG. 2, for convenience of explanation, only a minimum input/output of data is illustrated. That is, input/output of data for the processing units is not limited to the illustrated example, and input/output of data, which is not illustrated, is not prohibited, for example, input/output of data between the processing units or data between each of the processing units and an external device.

The communication I/F unit 11 is an interface that performs communication control with another device such as the information processing device 20 or the client terminal 30.

As an embodiment, as the communication I/F unit 11, a network interface card such as a LAN card may be used. For example, the communication I/F unit 11 may accept various instruction inputs from the client terminal 30. Examples of such inputs include various operations for a virtual machine operated on the information processing device 20 and the like in addition to an activation request of the virtual machine. In addition, the communication I/F unit 11 may transmit an output of the virtual machine operated on the information processing device 20, to the client terminal 30. Examples of such an output include display data of a desktop screen updated in accordance with an application program or the like that is being executed by the virtual machine or an instruction input from the client terminal 30, or display data of a difference between before and after the update.

The storage unit 13 is a storage device that stores data used for various programs such as an application program that realizes the function related to the above-described activation control service in addition to an OS executed by the control unit 15.

As an embodiment, the storage unit 13 may be provided as an auxiliary storage device in the activation control device 10. For example, as the storage unit 13, a hard disk drive (HDD), an optical disk, a solid state drive (SSD), or the like, may be used. The storage unit 13 may not be provided as an auxiliary storage device, and may also be provided as a main storage device in the activation control device 10. In this case, as the storage units 13, various semiconductor memory elements such as a random access memory (RAM) and a flash memory may be used.

The storage unit 13 stores activation setting data 13a, activation history data 13b, and activation priority level data 13c as examples of data used for a program executed by the control unit 15. In addition to such data, the following data may also be stored. For example, the storage unit 13 may also store account information given to the user and information on a network address of the client terminal 30.

The activation setting data 13a is data related to setting of activation of a virtual machine.

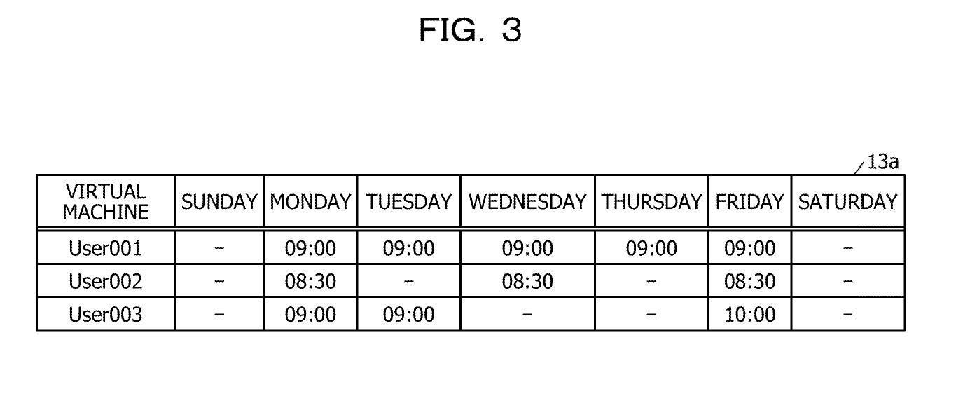

As an embodiment, as the activation setting data 13a, data associated with a setting time at which each virtual machine automatically is activated may be used. FIG. 3 is a diagram illustrating an example of the activation setting data 13a. In FIG. 3, three records related to virtual machines identified by virtual machine names User 001 to User 003 are extracted and illustrated, respectively. As illustrated in FIG. 3, common to the three virtual machines is setting in which the activation is not automatically performed on non-business days such as Saturday and Sunday. From among the three records, the record of the virtual machine “User 001” illustrated in the top record of the three records in FIG. 3 indicates that setting is performed in which the virtual machine is automatically activated at “9:00” in any day of the business days from Monday to Friday. In addition, the record of the virtual machine “User 002” illustrated in the middle record of the three records in FIG. 3 indicates that setting is performed in which the virtual machine is not automatically activated on Tuesday and Thursday but the virtual machine is automatically activated at “8:30” on Monday, Wednesday, and Friday. In addition, the record of the virtual machine “User 003” illustrated in the bottom record of the three records in FIG. 3 indicates that setting is performed in which the virtual machine is not automatically activated on Wednesday and Thursday, but the virtual machine is automatically activated at “9:00” on Monday and Tuesday and is automatically activated at “10:00” on Friday. Here, the case is described above in which the automatic activation of the virtual machines is set for each named day of the week, but a unit in which the automatic activation of the virtual machine is set may not be limited to a weekly unit or a named day-of-week unit. For example, a single setting time may be repeatedly used for each day, or a different setting time may be stored for each day, may be stored for each week such as a first week, a second week, and the like, may be stored for each month such as January, February, and the like, or may be stored for each year such as 2015, 2016, and the like.

The activation history data 13b is data related to a history of activation of virtual machines. The activation history data is an example of activation performance information.

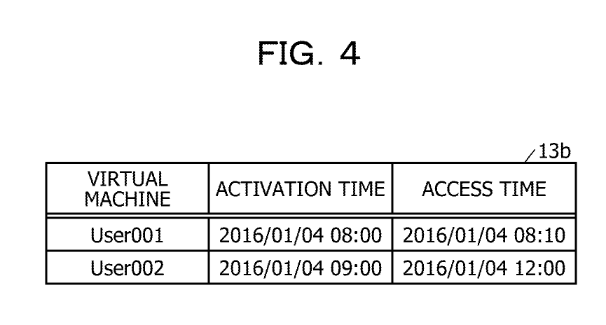

As an embodiment, as the activation history data 13b, data may be used in which a time at which each virtual machine has been activated is associated with a time at which an access to the virtual machine has been started. FIG. 4 is a diagram illustrating an example of the activation history data 13b. In FIG. 4, two records related to virtual machines identified by the virtual machine names User 001 and User 002 are extracted and illustrated, respectively. For example, the top record illustrated in the records in FIG. 4 indicates that the first access to the virtual machine User 001, for example, a user operation such as a login operation has been performed at 8:10 on January 4 in 2016 after the virtual machine “User 001” has been activated at 8:00 on January 4 in 2016. The computer may recognize that a time difference between the activation time and the access start time is 10 minutes when such a record is stored as a history. In addition, the bottom record illustrated in the records in FIG. 4 indicates that the first access to the virtual machine “User 002” has been performed at 12:00 on January 4 in 2016 after the virtual machine “User 002” has been activated at 9:00 on January 4 in 2016. The computer may recognize that a time difference between the activation time and the access start time is three hours when such a record is stored as a history.

Here, in FIG. 4, for convenience of explanation, the history having a single activation time and a single access start time is illustrated for each of the virtual machines, but a storage method of the records may not be limited to such examples. For example, the storage unit 13 may store histories of the respective virtual machines for each day, week, month, and named day of the week as the activation history data 13b, may accumulate and store the histories for each day, week, month, and named day of the week over a plurality of periods, or store a time difference between the activation time and the access start time instead of the activation time and the access start time.

In FIGS. 3 and 4, a case is described in which the activation setting data 13a and the activation history data 13b are stored in the storage unit 13 in a table format, but the embodiment is not limited to such a case. For example, the activation setting data 13a may be data described in a tag format by a markup language such as an extensible markup language (XML), or may be data described by a comma and a return such as comma-separated values (CSV).

The activation priority level data 13c is data related to a priority level in which a virtual machine is activated.

Here, “priority level” indicates a degree of a priority of activation of the virtual machine, and may be represented, for example, by an amount of a point. For example, a point may be defined by a time difference between an activation time and an access start time for each calendar attribute such as a day, a week, a month, or a named day of the week. The detail is described later, but as a calculation formula of a point, the following formula (1) may be used. Here, “addition value” in the following formula (1) is a value defined depending on an amount of the time difference between the activation time and the access start time, and for example, as “addition value”, a larger value may be set as the time difference becomes smaller, and a smaller value may be set as the time difference becomes larger. As described above, reflection of “previous point” is performed for the calculation of a point because the priority level is defined not by a single section in the history but by change to the entire history. Here, “weight” in the following formula (1) is a coefficient by which the previous point is multiplied, and for example, a constant that is larger than 0 and 1 or less may be set as “weight”.

The latest point=previous point*weight+addition value (1)

As an embodiment, as the activation priority level data 13c, data in which a priority level, for example, the above-described point has been associated with each of the virtual machines may be used. Here, when points are respectively calculated by different granularities such as a day, a week, a month, and a named day of the week, data in which a daily point, a weekly point, a monthly point, a named day-of-week point, and the overall point of these points are associated with each of the virtual machines are stored in the storage unit 13 as the activation priority level data 13c. Here, “overall point” indicates a point obtained by combining the daily point, the weekly point, the monthly point, and the named day-of-week point by performing specific statistical processing, for example, totaling, arithmetic average, weighted average or the likeon the daily point, the weekly point, the monthly point, and the named day-of-week point. Here, the case is described in which points are calculated by different granularities such as the day, the week, the month, and the named day of the week, but the points may not be calculated by the plurality of granularities, and at least one of the daily point, the weekly point, the monthly point, and the named day-of-week point may be stored.

The control unit 15 includes an internal memory that stores various programs and control data, and executes various types of processing using the various programs and the control data.

As an embodiment, the control unit 15 is provided as a central processing device, that is, a so-called CPU. The control unit 15 may not be provided as the central processing device, but may be provided as a micro processing unit (MPU). In addition, the control unit 15 may be realized by hardware wired logic such as an application specific integrated circuit (ASIC) or a field programmable gate array (FPGA).

The control unit 15 virtually realizes the following processing units by deploying the above-described activation control program as processes on a work area of a random access memory (RAM) such as a dynamic RAM (DRAM) or a static random access memory (SRAM), which is provided as a main storage device which is not illustrated.

For example, as illustrated in FIG. 2, the control unit 15 includes a monitoring unit 15a, a registration unit 15b, a calculation unit 15c, an update unit 15d, an activation start unit 15e, and an activation control unit 15f.

The monitoring unit 15a is a processing unit that monitors an access to a virtual machine.

As an embodiment, the monitoring unit 15a starts to monitor an access to the virtual machine from the client terminal 30 when the virtual machine is automatically activated on the information processing device 20 in accordance with an activation instruction of the activation control unit 15f described later. Here, just as an example, it is assumed that a desktop environment is provided for the client terminal 30 through the virtual machine. In this case, the monitoring unit 15a collects access logs of communication performed by a protocol such as a remote desktop protocol (RDP), secure shell (SSH), or virtual network computing (VNC) from a network device accommodated in the network NW, for example, a router or a switch. Using such access logs, the monitoring unit 15a monitors whether communication has been performed between the client terminal 30 and the virtual machine.

The registration unit 15b is a processing unit that registers an activation history related to the virtual machine.

As an embodiment, the registration unit 15b executes the following processing when the virtual machine has been automatically activated on the information processing device 20 in response to an activation instruction of the control unit 15f described later. That is, the registration unit 15b obtains an activation time from an OS or the like which is not illustrated. After that, when an access to the virtual machine has been detected by the monitoring unit 15a, the registration unit 15b obtains an access start time from the OS or the like. In addition, the registration unit 15b creates a new entry in the activation history data 13b stored in the storage unit 13, and registers the virtual machine, the activation time, and the access start time in the new entry so as to associate the activation time and the access start time with the virtual machine. The registration of the activation history in the activation history data 13b is described above, but deletion of an obsolete activation history may also be performed.

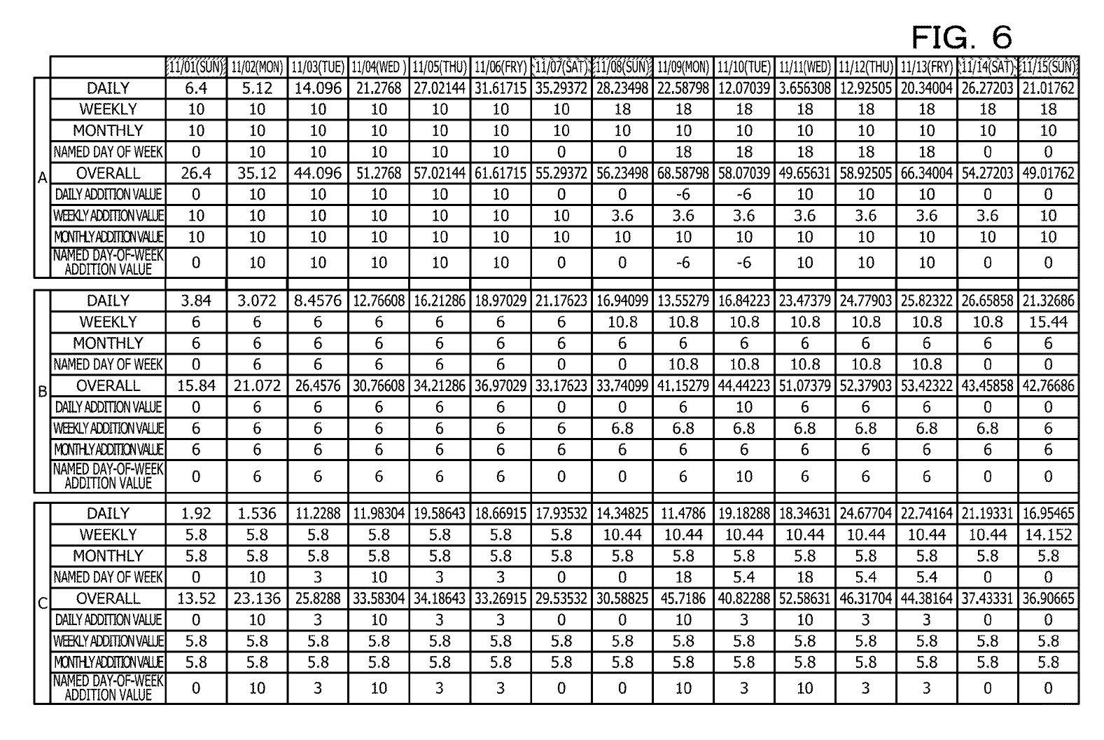

The calculation unit 15c is a processing unit that calculates the above-described priority level. Here, as an example, a calculation method of a daily point is described, and a calculation method of a weekly point, a monthly point, and a named day-of-week point is described later with reference to FIG. 6. The calculation unit 15c is an example of a specification unit.

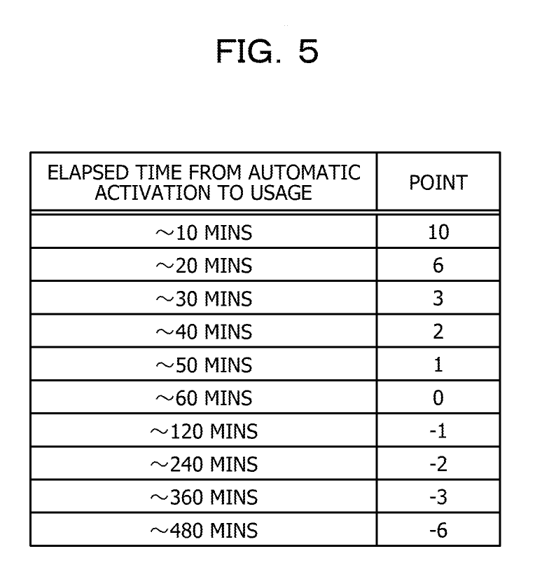

As one aspect, the calculation unit 15c monitors the activation history data 13b stored in the storage unit 13. In addition, the calculation unit 15c starts to calculate a daily point used for activation order control of the following day of a date at which a new entry has been added to the activation history data 13b each time the new entry is added to the activation history data 13b. In the following description, for convenience of explanation, the date of “today” in which calculation of the daily point is executed may be referred to as “d”, the previous day may be referred to as “d−1”, and the date of the following day may be referred to as “d+1”. That is, the calculation unit 15c calculates a time difference between an activation time and an access start time included in the new entry of the above-described activation history data 13b. After that, the calculation unit 15c derives an addition value in the above-described formula (1), that is, “daily addition value” from the time difference between the activation time and the access start time. When the daily addition value is derived as described above, as an example, a correspondence relationship between the time difference and the daily addition value, which is illustrated in FIG. 5, may be utilized

FIG. 5 is a diagram illustrating an example of a correspondence relationship between a time difference and a daily addition value. For example, when the time difference is 10 minutes or less, “10” is obtained as the daily addition value. In addition, when the time difference is more than 10 minutes to 20 minutes, “6” is obtained as the daily addition value. As the time difference becomes larger as described above, the smaller value is derived as the daily addition value. In addition, when the time difference is more than 50 minutes to 60 minutes, “0” is obtained as the daily addition value. When the time difference is extended to more than 60 minutes, a negative value is obtained as the daily addition value using the time difference of more than 50 minutes to 60 minutes as a boundary. For example, when the time difference is more than 60 minutes to 120 minutes, “−1” is obtained as the daily addition value. In addition, when the time difference is extended to more than 360 minutes to 480 minutes, the value derived as the daily addition value is reduced to “−6”.

After the daily addition value has been derived as described above, the calculation unit 15c calculates a daily point used for desired activation order control of the following day “d+1” in accordance with the above-described formula (1). That is, the calculation unit 15c substitutes the previously-derived daily addition value into the term of “addition value” described in the above-described formula (1). In addition, the calculation unit 15c extracts a daily point associated with the same virtual machine as the virtual machine in which the new entry has been added to the activation history data 13b, from among daily points included in entries of the activation priority level data 13c. The daily point extracted from the activation priority level data 13c as described above corresponds to the daily point calculated in the previous day “d−1”, which is the daily point used for the activation order control of the today “d” and is substituted into the term of “previous point” described in the above-described formula (1). When the daily addition value and the daily point used for the activation order control of the today “d” are substituted into the above-described formula (1), a daily point used for the activation order control of the following day “d+1” is calculated.

As another aspect, each time a date of the calendar time referred to from the OS or the like is changed, the calculation unit 15c identifies a virtual machine to which automatic activation is not set in a named day of the week of today after the date has been changed with reference to the activation setting data 13a. In addition, the calculation unit 15c sets, to zero, a value of a daily addition value substituted into the term of “addition value” described in the above-described formula (1) for each of the previously-identified virtual machines, and calculates a daily point used for activation order control of the following day “d+1” for a virtual machine to which automatic activation is set similar to the above-described example. As described above, the calculation unit 15c calculates the daily point for the day on which automatic activation is not set to the virtual machine.

The update unit 15d is a processing unit that updates a priority level related to activation of the virtual machine. The update unit 15d is an example of a determination unit.

As an embodiment, when the daily point used for activation order control of the following day “d+1” has been calculated by the calculation unit 15c, the update unit 15d executes the following processing. That is, the update unit 15d updates the daily point so as to overwrite a daily point in an entry corresponding to the virtual machine for which the daily point has been calculated by the calculation unit 15c from among entries of the activation priority level data 13c stored in the storage unit 13, from the daily point of the today “d” to the daily point of the following day “d+1”. Here, the case is described in which the daily point of the activation priority level data 13c is overwritten and updated, but an obsolete daily point may be stored without deletion so that the date is further associated with the virtual machine and the daily point.

The activation start unit 15e is a processing unit that starts to activate a virtual machine.

As an embodiment, the activation start unit 15e monitors the activation setting data 13a stored in the storage unit 13. That is, the activation start unit 15e monitors, at specific intervals, whether there exists an entry having a setting time corresponding to a calendar time, which is measured by the OS or the like, from among entries of the activation setting data 13a. Here, when there exists an entry having a setting time corresponding to the calendar time, which is measured by the OS or the like, it may be determined that the setting time corresponds to timing at which a virtual machine included in the entry is automatically activated. In this case, the activation of the virtual machine for which the automatic activation has been set is started.

The activation control unit 15f is a processing unit that controls activation of the virtual machine.

As an embodiment, when the automatic activation of the virtual machine has been started, the activation control unit 15f determines whether there is a plurality of virtual machines for each of which automatic activation has been set. At this time, when there is only a single virtual machine for which the automatic activation has been set, the activation control unit 15f transmits an activation instruction of the virtual machine for which the automatic activation has been set, to the information processing device 20. In addition, in a case where there is a plurality of virtual machines for each of which the automatic activation has been set, the activation control unit 15f further determines whether there exist virtual machines activated in the same host in the information processing device 20, from among the plurality of virtual machines.

At this time, when the plurality of virtual machines is not activated in the same host in the information processing device 20, it may be determined that the multiplicity of the activation of virtual machines does not increase in the host machine because the plurality of virtual machines is activated in different hosts. In this case, the activation control unit 15f transmits an activation instruction of each of the virtual machines to the information processing device 20.

Here, when the plurality of virtual machines is activated in the same host in the information processing device 20, it is understood that the multiplicity of the activation of virtual machines increases in the host. In this case, the activation control unit 15f reads a daily point for each of the plurality of virtual machines, with reference to the activation priority level data 13c stored in the storage unit 13. In addition, the activation control unit 15f sets activation order of the plurality of virtual machines by sorting the plurality of virtual machines, for example, in descending order from the highest point from among specific points such as a daily point and an overall point. In addition, the activation control unit 15f transmits an activation instruction of each of the virtual machines to the information processing device 20 in accordance with the activation order.

### SPECIFIC EXAMPLE

A specific example of a calculation method of a point and activation control of a virtual machine are described below with reference to FIG. 6. FIG. 6 is a diagram illustrating an example of a calculation result of points. FIG. 6 illustrates transition of daily points, weekly points, monthly points, named day-of-week points, overall points, daily addition values, weekly addition values, monthly addition values, and named day-of-week addition values related to the three virtual machines such as the virtual machines A, B, and C over for 15 days from November 1 (Sunday) to November 15 (Sunday). In addition, FIG. 6 illustrates points calculated under a condition under which a daily addition value is derived in accordance with the correspondence relationship between the time difference and the daily addition value illustrated in FIG. 5 and “0.8” is set as an example of “weight” described in the above-described formula (1).

Here, the calculation method of points is the same for any date, so that, in the following description, a case is described in which points of the virtual machine A on November 9 (Monday) on behalf of 15 days from November 1, (Sunday) to November 15 (Sunday) are calculated for the calendar attributes such as the day, the week, the month, and the named day of the week.

(1) Daily Point

For example, the daily point of the virtual machine A on November 9 (Monday) is calculated at a stage at which the calendar time obtained from the OS or the like has been changed to November 8 (Sunday). That is, on November 8 (Sunday), automatic activation of the virtual machine A is not set. Therefore, “0” is substituted into the term of “addition value” described in the above-described formula (1), as the daily addition value. In addition, the daily point calculated on November 7 (Saturday), that is, the daily point “28.23498” on November 8 (Sunday) is substituted into the term of “previous point” described in the above-described formula (1). Therefore, as a result of calculation of “28.23498*0.8+0” based on the above-described formula (1), “22.58798” is obtained as the daily point of the virtual machine A of November 9 (Monday).

In addition, a daily point of the virtual machine A on November 10 (Tuesday) is calculated at a stage at which an entry of an activation time and an access start time of the virtual machine A on November 9 (Monday) has been registered in the activation history data 13b. As described above, in FIG. 6, an example is illustrated in which the virtual machine A has not been activated due to a reason of a non-business day or the like, so that a time difference between the activation time and the access start time becomes 480 minutes or more, and “−6” that is the minimum value is derived as the daily addition value. In this case, “−6” is substituted into the term of “addition value” described in the above-described formula (1) as the daily addition value. In addition, the daily point calculated on November 8 (Sunday), that is, the daily point “22.58798” on November 9 (Monday) is substituted into the term of “previous point” described in the above-described formula (1). Therefore, as a result of calculation of “22.58798*0.8+(−6)” based on the above-described formula (1), “12.07039” is obtained as the daily point of the virtual machine A on November 10 (Tuesday). Here, the calculation method of daily point of the virtual machine A is described above, but similarly, daily points may be calculated for the virtual machine B and the virtual machine C as well.

(2) Weekly Point

For example, a weekly point of the virtual machine A for a week from November 8 (Sunday) to November 14 (Saturday) is calculated at a stage at which daily addition values have been confirmed after the previous week, that is, a week from November 1 (Sunday) to November 7 (Saturday) has elapsed. In a case in which the daily addition values in the week from November 1 (Sunday) to November 7 (Saturday) have been confirmed, when specific statistical processing, for example, calculation of an average value, extraction of a mode value, or the like is executed for the daily addition values, a weekly addition value for a week from November 1 (Sunday) to November 7 (Saturday) is calculated. For example, when an average value of the daily addition values is calculated as an example of the above-described statistical processing, “10” is derived as the weekly addition value for the week from November 1 (Sunday) to November 7 (Saturday) by calculation of “(10+10+10+10+10)/5”. After that, “10” is substituted into the term of “addition value” described in the above-described formula (1) as the weekly addition value. In addition, the weekly point calculated at the stage at which the week from October 25 (Sunday) to October 31 (Saturday) has elapsed, that is, the weekly point “10” of the week from November 1 (Sunday) to November 7 (Saturday) is substituted into the term of “previous point” described in the above-described formula (1). Therefore, as a result of calculation of “10*0.8+10” based on the above-described formula (1), “18” is obtained as the weekly point of the virtual machine A in the week from November 1 (Sunday) to November 7 (Saturday). Here, the calculation method of the weekly point of the virtual machine A is described above, but similarly, weekly points may be calculated for the virtual machine B and the virtual machine C as well.

(3) Monthly Point

For example, a monthly point of the virtual machine A in November is calculated at the stage at which the daily addition values have been confirmed after the previous month, that is, the month of October has elapsed. In a case in which the daily addition values have been defined in the month of October as described above, when specific statistical processing, for example, calculation of an average value, extraction of a mode value, or the like, is executed for the daily addition values, a monthly addition value in the month of October is calculated. For example, in a case in which an average value of the daily addition values has been calculated as an example of the above-described statistical processing, when a monthly addition value in the month of October is “10” (not illustrated), “10” is substituted into the term of “addition value” described in the above-described formula (1) as the monthly addition value. In addition, when the monthly point calculated at the stage at which the month of September has elapsed, that is, the monthly point of the month of October is “12.5” (not illustrated), the monthly point “12.5” is substituted into the term of “previous point” described in the above-described formula (1). Therefore, as a result of calculation of “12.5*0.8+10” based on the above-described formula (1), “10” is obtained as the monthly point of the virtual machine A in November. Here, the calculation method of the monthly point of the virtual machine A is described above, but similarly, monthly points may be calculated for the virtual machine B and the virtual machine C as well.

(4) Named Day-of-Week Point

For example, a named day-of-week point of the virtual machine A on November 9 (Monday) is calculated at a stage at which an entry of an activation time and an access start time of the virtual machine A on November 2 (Monday), that is, one week before November 9 (Monday) has been registered in the activation history data 13b. That is, as illustrated in FIG. 6, “10” that is the maximum value derived from a time difference between the activation time and the access start time of the virtual machine A on November 2 (Monday) is derived as a named day-of-week addition value. In this case, “10” is substituted into the term of “addition value” described in the above-described formula (1) as the named day-of-week addition value. In addition, the named day-of-week point calculated on October 26 (Monday), that is, the named day-of-week point “10” of November 2 (Monday) is substituted into the term of “previous point” described in the above-described formula (1). Therefore, as a result of calculation of “10*0.8+10” based on the above-described formula (1), “18” is obtained as the named day-of-week point of the virtual machine A on November 9 (Monday). Here, the calculation method of the named day-of-week point of the virtual machine A is described above, but similarly, named day-of-week points may be calculated for the virtual machine B and the virtual machine C as well.

(5) Overall Point

An overall point is calculated at a stage at which a daily point that is the smallest granularity from among the calendar attributes has been calculated. For example, the overall point of the virtual machine A on November 9 (Monday) may be calculated at a stage at which a daily point of the virtual machine A on November 9 (Monday) has been calculated. That is, the overall point is calculated when specific statistical processing, for example, processing such as totaling, arithmetic average, or weighted average is executed for a daily point, a weekly point, a monthly point, and a named day-of-week point of the virtual machine A on November 9 (Monday). For example, when the overall point is calculated by the totaling, “68.58798” is obtained as the overall point by the calculation of “22.58798+18+10+18”. Here, the calculation method of the overall point of the virtual machine A is described above, but similarly, the overall points may be calculated for the virtual machine B and the virtual machine C as well.

(6) Activation Control of a Virtual Machine

Under the following condition, activation order control of the virtual machines A, B, and C on November 9, 10, and 11 is described below. That is, a case is assumed in which setting times of automatic activation on business days other than non-business days such as Saturday and Sunday are the same between the virtual machines A, B, and C, and the virtual machines A, B, and C are activated in the same host.

In addition, it is assumed that utilization trends of users of the virtual machines A, B, and C are as follows. That is, as illustrated in FIG. 6, the user of the virtual machine A typically utilizes the virtual machine immediately after the activation (trend 1), and the user of the virtual machine B utilizes the virtual machine after the activation later than the user of the virtual machine A (trend 2), and the user of the virtual machine C utilizes the virtual machine after the activation earlier than the user of the virtual machine B only on Monday and Wednesday (trend 3).

In a case in which there are such trends, even when there are some irregulars that deviate from the trends, it may be expected that the activation standby times of the virtual machines A, B, and C are reduced in total by increasing the reproducibility of setting of activation order in which the virtual machines are started in order from “the virtual machine A, the virtual machine C, to the virtual machine B” on Monday and Wednesday and the virtual machines are activated in order from “the virtual machine A, the virtual machine B, to the virtual machine C” on the other days of the week, in accordance with the trends 1 to 3, as compared with the case in which the irregulars are dealt with.

Here, as illustrated in FIG. 6, a case is assumed in which the following irregular occurs. For example, a case in which the user of the virtual machine A has not utilized the virtual machine A for two days of November 9 and 10 due to a reason of non-business days or the like (irregular 1) and a case in which the user of the virtual machine B has a different utilization trend only on November 10 (irregular 2) are assumed.

For example, even in a case in which the above-described irregular 1 occurs, “the virtual machine A→the virtual machine C→the virtual machine B” that is the activation order corresponding to Monday may be set when the virtual machines A, B, and C are sorted so that the daily points or the overall points are arranged in descending order on November 9 (Monday). In addition, even in a case in which the above-described irregular 1 and irregular 2 occur, “virtual machine A→virtual machine B→virtual machine C” that is the activation order corresponding to days of the week other than Monday and Wednesday may be set when the virtual machines A, B, and C are sorted so that the daily points or the overall points are arranged in descending order on November 10 (Tuesday). In addition, the activation of the virtual machine A becomes late due to the above-described irregular 1 but “virtual machine C→virtual machine B→virtual machine A” that is the activation order in which the activation of the virtual machine C the utilization of which on Wednesday is earlier than the virtual machine B is prioritized may be set when the virtual machines A, B, and C are sorted so that the daily points or the overall points are arranged in descending order on November 11 (Wednesday).

[Flow of Processing]

A flow of processing of the activation control device 10 according to the embodiment is described below. Here, (1) history registration processing, (2) priority level update processing, and (3) activation control processing that are executed by the activation control device 10 are described below in such order.

(1) History Registration Processing

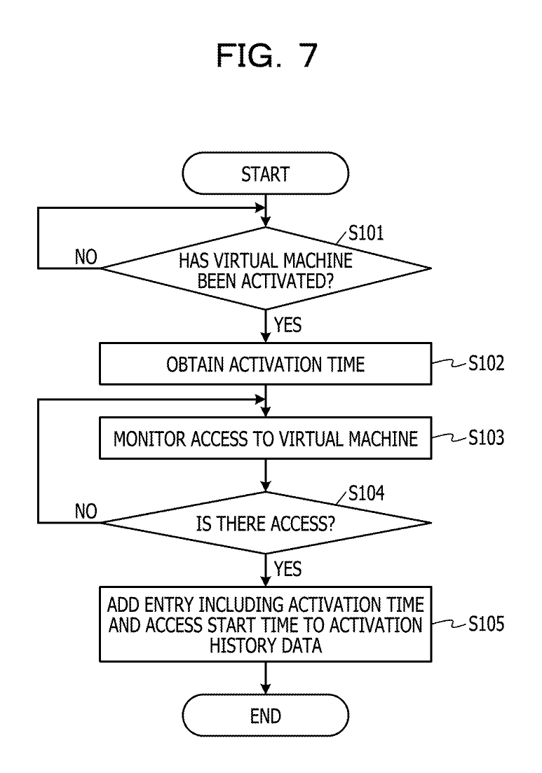

FIG. 7 is a flowchart illustrating a procedure of the history registration processing according to the first embodiment. As an example, such pieces of processing are executed in parallel for virtual machines automatically activated on the information processing device 20, respectively. As illustrated in FIG. 7, when a virtual machine has been automatically activated on the information processing device 20 (Yes in Step S101), the registration unit 15b obtains an activation time from the OS or the like (Step S102).

After that, the monitoring unit 15a monitors an access to the virtual machine from the client terminal 30 (Step S103). In addition, when an access to the virtual machine has been detected (Yes in Step S104), the registration unit 15b obtains an access start time from the OS or the like, creates a new entry in the activation history data 13b stored in the storage unit 13, and registers the virtual machine, the activation time, and the access start time in the new entry so as to associate the activation time and the access start time with the virtual machine (Step S105), and the processing ends.

(2) Priority Level Update Processing

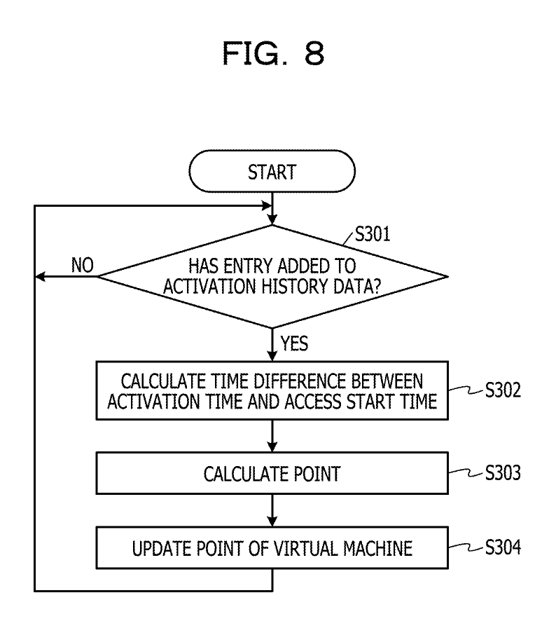

FIG. 8 is a flowchart illustrating a procedure of the priority level update processing according to the first embodiment. As an example, such processing is repeatedly executed each time a new entry is added to the activation history data 13b. As illustrated in FIG. 8, when a new entry has been added to the activation history data 13b (Yes in Step S301), the calculation unit 15c calculates a time difference between an activation time and an access start time included in the new entry of the above-described activation history data 13b (Step S302).

After that, the calculation unit 15c calculates a point of the virtual machine in which the new entry has been added to the activation history data 13b from the time difference between the activation time and the access start time in accordance with the above-described formula (1) (Step S303).

After that, the update unit 15d updates a daily point so as to overwrite a daily point in an entry corresponding to the virtual machine on which the calculation in Step S303 has been performed to the point calculated in Step S303, from among entries of the activation priority level data 13c stored in the storage unit 13 (Step S304), and the flow returns to the processing of Step S301.

(3) Activation Control Processing

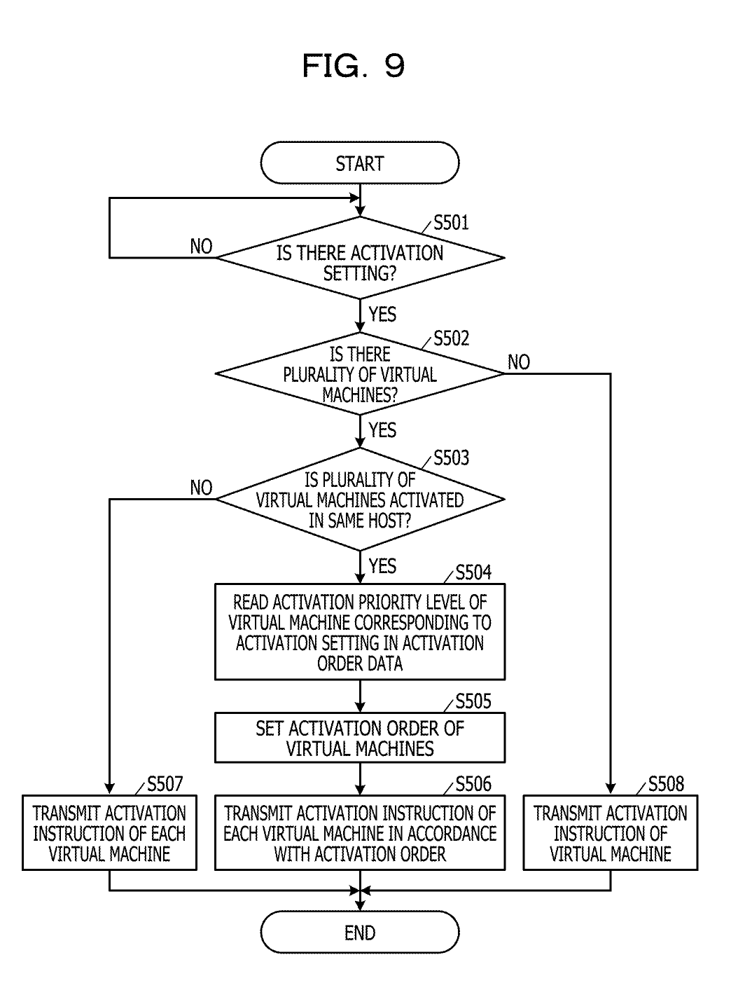

FIG. 9 is a flowchart illustrating a procedure of the activation control processing according to the first embodiment. As illustrated in FIG. 9, when there exists an entry having a setting time corresponding to the calendar time measured by the OS or the like from among entries of the activation setting data 13a (Yes in Step S501), activation of a virtual machine to which automatic activation has been set is started. In this case, the activation control unit 15f determines whether there is a plurality of virtual machines to each of which the automatic activation has been set (Step S502).

At this time, when there is a plurality of virtual machines to each of which the automatic activation has been set (Yes in Step S502), the activation control unit 15f further determines whether there exist virtual machines activated in the same host in the information processing device 20 from among the plurality of virtual machines (Step S503).

Here, when the plurality of virtual machines is activated in the same host in the information processing device 20 (Yes in Step S503), it is determined that the multiplicity of activation of virtual machines increases in the host. In this case, the activation control unit 15f reads a daily point for each of the plurality of virtual machines with reference to the activation priority level data 13c stored in the storage unit 13 (Step S504). Here, just as an example, a case is described in which activation order is set using a daily point, but the activation order may be set using another type of a point such as a weekly point, a monthly point, a named day-of-week point, or an overall point of these points.

In addition, the activation control unit 15f sets the activation order of the virtual machines by sorting the plurality of virtual machines in descending order from a high daily point (Step S505). In addition, the activation control unit 15f transmits an activation instruction of each of the virtual machines to the information processing device 20 in accordance with the activation order (Step S506), and the processing ends.

In addition, when the plurality of virtual machines is not activated in the same host in the information processing device 20 (No in Step S503), the plurality of virtual machines is activated in different hosts, so that it may be determined that the multiplicity of activation of virtual machines does not increase in the host machine. In this case, the activation control unit 15f transmits an activation instruction of each of the virtual machines to the information processing device 20 (Step S507), and the processing ends.

When there exists only a single virtual machine to which automatic activation has been set (No in Step S502), the activation control unit 15f transmits an activation instruction of the virtual machine to which the automatic activation has been set, to the information processing device 20 (Step S508), and the processing ends.

[One Aspect of the Effect]

As described above, the activation control device 10 according to an embodiment controls activation of the plurality of virtual machines in accordance with the activation order of the virtual machines, which has been set based on the respective time differences from activation of the virtual machines to start of accesses to the virtual machines. Therefore, a case in which a virtual machine not immediately used by the user at a stage at which the virtual machine has been activated is started earlier or a case in which a virtual machine immediately used by the user at a stage at which the virtual machine has been activated is started later may be reduced. Thus, in the embodiment, activation standby times of the virtual machines may be reduced.

### Second Embodiment

The embodiment of the device of the technology discussed herein is described above, but the technology discussed herein may be implemented with various different configurations in addition to the above-described embodiment. Therefore, another embodiment included in the technology discussed herein is described below.

[Manual Setting of the Activation]

In the above first embodiment, the case in which a virtual machine is automatically activated is described, but an activation priority level may be updated even when the virtual machine is manually started. For example, in a case in which the virtual machine has been manually activated, when there exists a negative value from among a daily point, a weekly point, a monthly point, a named day-of-week point, and an overall point of these points, the point having the negative value may be set to “0”.

[Modification of the Virtual Machine]

In the above first embodiment, the virtual machine that provides the desktop environment is described, but the first embodiment may be applied to a case in which a virtual machine other than the virtual machine that provides the desktop environment is activated on the information processing device 20. For example, in a case in which a virtual machine that provides a function of a web server is activated on the information processing device 20, a time difference from activation of the web server to usage of a service provided by the web server may be calculated when communication of a protocol of a hypertext transfer protocol (HTTP) is monitored.

[Activation Control Program]

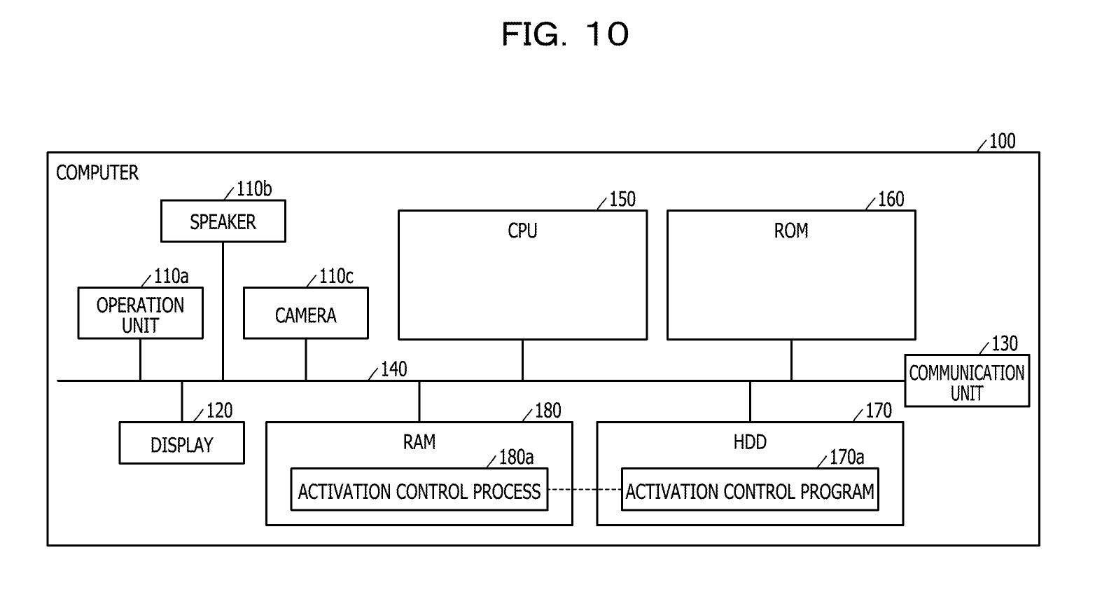

In addition, the various types of processing described in the above embodiments may be realized when a program prepared in advance is executed through a computer such as a personal computer, a workstation, or the like. Therefore, in the following description, an example of a computer that executes an activation control program having a function similar to that of the above-described embodiments is described below with reference to FIG. 10.

FIG. 10 is a diagram illustrating a hardware configuration example of the computer that executes the activation control program according to the first embodiment and the second embodiment. As illustrated in FIG. 10, a computer 100 includes an operation unit 110a, a speaker 110b, a camera 110c, a display 120, and a communication unit 130. In addition, the computer 100 includes a CPU 150, a read only memory (ROM) 160, a hard disk drive (HDD) 170, and a random access memory (RAM) 180. The units 110s to 180 are coupled to each other through a bus 140.

As illustrated in FIG. 10, in the HDD 170, an activation control program 170a is stored that realizes functions similar to those of the monitoring unit 15a, the registration unit 15b, the calculation unit 15c, the update unit 15d, the activation start unit 15e, and the activation control unit 15f described in the above first embodiment. In the activation control program 170a, programs may be combined or separated similar to the configuration elements such as the monitoring unit 15a, the registration unit 15b, the calculation unit 15c, the update unit 15d, the activation start unit 15e, and the activation control unit 15f illustrated in FIG. 2. That is, not all of the pieces of data described in the above first embodiment may be stored in the HDD 170, and data used for the types of processing may be stored in the HDD 170.

Under such an environment, the CPU 150 reads the activation control program 170a from the HDD 170 and deploys the activation control program 170a to the RAM 180. As a result, as illustrated in FIG. 10, the activation control program 170a functions as an activation control process 180a. The activation control process 180a deploys various data read from the HDD 170 to an area allocated to the activation control process 180a in a storage area included in the RAM 180, and executes various types of processing using the various types of deployed data. For example, an example of the processing executed by the activation control process 180a includes the processing each illustrated in FIGS. 7 to 9. In the CPU 150, not all of the processing units described in the above first embodiment may operate, and a processing unit corresponding to processing that is an execution target may be virtually realized.

The above-described activation control program 170a may not be stored in the HDD 170 or the ROM 160 from the beginning. For example, the activation control program 170a is stored in a “portable physical medium”, which is inserted into the computer 100, such as a so-called flexible disk (FD), a compact disk (CD)-ROM, a digital versatile disk (DVD), an optical magnetic disk, or an integrated circuit (IC) card. Then, the computer 100 may obtain the activation control program 170a from the portable physical medium and executes the activation control program 170a. Alternatively, the activation control program 170a is stored in a further computer or a server device coupled to the computer 100 through a public line, the Internet, a LAN, a WAN, or the like, and the computer 100 may obtain the activation control program 170a from the further computer or the server device and execute the activation control program 170a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing an activation control program that causes a computer to execute a process, the process comprising:
specifying a time until a specific access to each of a plurality of virtual machines has been detected after an activation of each of the plurality of virtual machines based on pieces of activation history data of the plurality of virtual machines;
determining activation order for the plurality of virtual machines based on the specified times; and
activating the plurality of virtual machines in accordance with the determined activation order.

2. The non-transitory computer-readable storage medium according to claim 1, wherein
in the determining, high activation order is determined as the specified time becomes short.

3. The non-transitory computer-readable storage medium according to claim 1, wherein
in the determining, the activation order is determined for each day, week, month, or named day of the week.

4. An activation control method executed by a computer, the activation control method comprising:
specifying a time until a specific access to each of a plurality of virtual machines has been detected after an activation of each of the plurality of virtual machines based on pieces of activation history data of the plurality of virtual machines;
determining activation order for the plurality of virtual machines based on the specified times; and
activating the plurality of virtual machines in accordance with the determined activation order.

5. An activation control device comprising:
a memory; and
a processor coupled to the memory and the processor configured to:
specify a time until a specific access to each of a plurality of virtual machines has been detected after an activation of each of the plurality of virtual machines based on pieces of activation history data of the plurality of virtual machines;
determine activation order for the plurality of virtual machines based on the specified times; and
activate the plurality of virtual machines in accordance with the determined activation order.
